(19) United States
(12) Patent Application Publication
(10) Pub. No.: US 2026/0368521 A1
(43) Pub. Date: Nov. 19, 2026

(54) SYSTEMS AND METHODS FOR SCALING LANGUAGE MODELS

(71) Applicant: Cerebras Systems Inc., Sunnyvale, CA (US)

(72) Inventors: Nolan Dey, Sunnyvale, CA (US); Bin Zhang, Sunnyvale, CA (US); Shane Bergsma, Sunnyvale, CA (US); Joel Hestness, Sunnyvale, CA (US)

(21) Appl. No.: 19/667,519

(22) Filed: May 4, 2026

Related U.S. Application Data
(60) Provisional application No. 63/805,986, filed on May 15, 2025.

(51) Int. Cl. G06N 3/08; G06N 3/0464

(52) U.S. Cl. CPC G06N 3/08; G06N 3/0464

(57) ABSTRACT

The present disclosure describes scaling model dimensions and transferring optimized hyperparameters for compute-efficient training and/or inference with deep learning models. A method for configuring a model of a model type, the model including a number of parameters, includes accessing a base model selected based on the model type and on the number of parameters, wherein the base model comprises a base width and a base depth, parameterizing, using processing circuitry, the base model to identify a target aspect ratio of the model, and tuning, using the processing circuitry, the model based on the target aspect ratio to generate a tuned model, wherein the tuned model is usable to be trained more efficiently relative to the model.

### CROSS-REFERENCE TO RELATED APPLICATION

This application claims the benefit of U.S. Provisional Patent Application No. 63/805,986, filed May 15, 2025, which is incorporated by reference herein in its entirety.

### TECHNICAL FIELD

The present disclosure relates to scaling model dimensions and transferring optimized hyperparameters for compute-efficient training and/or inference with deep learning models.

### SUMMARY

Training deep learning models as size (e.g., number of parameters) increase may lead to better performance but may be increasingly compute-inefficient. For example, training larger models (e.g., large language models (LLMs)) on larger datasets may demonstrate remarkable results with significant increase to computational cost (e.g., number of floating-point operations (FLOPs) to achieve acceptable accuracy). In some approaches, the computational cost may be managed by adjusting the training configuration by defining hyperparameters such as model width and depth, dataset size, batch size, number of training steps, etc., to optimize resource allocation and minimize the training objective(s). However, configuring the hyperparameters may be prohibitively compute-intense as model size increases, e.g., using search and optimization algorithms (e.g., grid search, random search, Bayesian optimization, etc.). In some approaches, an optimized hyperparameter set for a smaller model may be found and scaled up to the larger model size. However, these hyperparameter transfer algorithms may not lead to a training configuration that is optimized for the larger model and may demonstrate less compute-efficient training in some instances.

Accordingly, there is a need for techniques that ensure transfer of optimized hyperparameters for training larger models as model size scales.

To address the aforementioned issues and more, the present disclosure describes one or more embodiments including one or more of systems, methods, non-transitory computer-readable media, etc., that enable optimized hyperparameter transfer for training deep learning models. In some embodiments, a framework is described that includes parameterizations (e.g., sets of rules) used for scaling model and optimized hyperparameters with model size. For example, a base model's depth (e.g., number of model layers) and width (e.g., number of nodes in a model layer) may be simultaneously scaled based on an optimized aspect ratio (e.g., a width-to-depth ratio, a depth-to-width ratio) of the base model to determine a training configuration that is compute-efficient for a larger model of the same type. For example, the depth and width of a deep learning model may be tuned based on the optimized aspect ratio such that the deep learning model may be trained using fewer compute operations relative to training the untuned model.

In some aspects, the framework provides a training configuration that enables transfer of optimized hyperparameters (e.g., of a base model) across changes in model size, depth, and/or width. For example, an optimized learning rate of the base model may remain optimized for a model having a larger size and a similar aspect ratio. In some aspects, the framework may ensure a larger compute-efficient range based on the aspect ratio for the training configuration. For example, the optimized hyperparameters may be transferred to a larger model having an aspect ratio within a range around the optimized aspect ratio, enabling flexible training configurations that remain compute-efficient.

In some embodiments, the framework includes a computer-implemented method for configuring a model of a model type, wherein the model comprises a number of parameters. The method includes accessing a base model selected based on the model type and on the number of parameters, wherein the base model includes a base width and/or a base depth. The method includes parameterizing, using processing circuitry, the base model to identify a target aspect ratio of the model, tuning, using the processing circuitry, the model based on the target aspect ratio to generate a tuned model, wherein the tuned model is usable to be trained more efficiently relative to the model. For example, training the tuned model may use fewer operations (e.g., floating point operations (FLOPs) than training the model prior to tuning.

In some embodiments, the method may include generating the base model. In some embodiments, the model may include a model depth and a model width, and parameterizing the base model may include determining, based on at least one of the base width or the base depth, an optimized aspect ratio of the base model, wherein the optimized aspect ratio is associated with an optimized set of hyperparameters of the base model, and identifying the target aspect ratio based on the optimized aspect ratio.

In some embodiments, tuning the model may include modifying at least one of the model depth or the model width based on a target aspect ratio. In some embodiments, the method may include tuning a training configuration of the model to determine a set of hyperparameters of the tuned model based on the target aspect ratio. In some embodiments, determining the set of hyperparameters may include re-scaling an optimized set of hyperparameters using at least one of the model depth or the model width. The set of hyperparameters may include one or more of a learning rate, a weight decay, a batch size, a dataset size, a number of training steps, or a training step size.

In some embodiments, the model may include at least one residual layer, wherein an output of the at least one residual layer is scaled using the model depth. In some embodiments, the output is divided by the model depth to the power of one.

In some embodiments, the method may include training the tuned model, wherein training the tuned model may include using fewer compute operations relative to training the model.

In some embodiments, a plurality of model weights of the tuned model may be stored in memory coupled to one or more devices. The method may include transmitting, from the memory, respective model weights of the tuned model to each of the one or more devices and concurrently training respective model layers of the tuned model based on the respective model weights using the one or more devices.

In some embodiments, a system is described for configuring a model of a model type. The system may include processing circuitry configured to access a base model selected based on the model type and on the number of parameters, wherein the base model comprises a base width and a base depth, parameterize the base model to identify a target aspect ratio of the model, and tune the model based on the target aspect ratio to generate a tuned model, wherein the tuned model is usable to be trained more efficiently relative to the model.

In some embodiments, a non-transitory computer-readable medium (CRM) is described, wherein the CRM includes one or more instructions for configuring a model of a model type. The one or more instructions, when executed by processing circuitry, may cause the processing circuitry to access a base model selected based on the model type and on the number of parameters, wherein the base model comprises a base width and a base depth, parameterize the base model to identify a target aspect ratio of the model, and tune the model based on the target aspect ratio to generate a tuned model, wherein the tuned model is usable to be trained more efficiently relative to the model.

### BRIEF DESCRIPTION OF THE DRAWINGS

The following description includes description of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in some embodiments” appearing herein describe various embodiments and implementations, and do not necessarily all refer to the same one or more embodiment. However, they are also not necessarily mutually exclusive. It should be noted that for clarity and ease of illustration, these drawings are not necessarily made to scale. In the drawings:

FIG. 1 depicts an example system for generating a tuned model using a parameterized base model, in accordance with some embodiments of this disclosure;

FIG. 2 depicts an example system for determining tuned model parameters and/or optimized hyperparameters to generate a tuned model using a parameterized base model, in accordance with some embodiments of this disclosure;

FIG. 3 is a flowchart of an example process for tuning a model using a parameterized base model, in accordance with some embodiments of this disclosure;

FIG. 4 is a flowchart of an example process for generating a training configuration based on optimized hyperparameters of a base model and training a tuned model using the training configuration, in accordance with some embodiments of this disclosure;

FIG. 5 depicts an example compute accelerator including a plurality of PEs coupled to an interface, in accordance with some embodiments of this disclosure;

FIG. 6 depicts an example configuration of a compute accelerator including a plurality of PEs disposed at a single substrate, in accordance with some embodiments of this disclosure;

FIG. 7 depicts a block diagram illustrating an example processing element and some components thereof, in accordance with some embodiments of this disclosure; and

FIG. 8 is a flowchart of an example process for training a model and/or performing inference using the trained model, in accordance with some embodiments of this disclosure.

### DETAILED DESCRIPTION

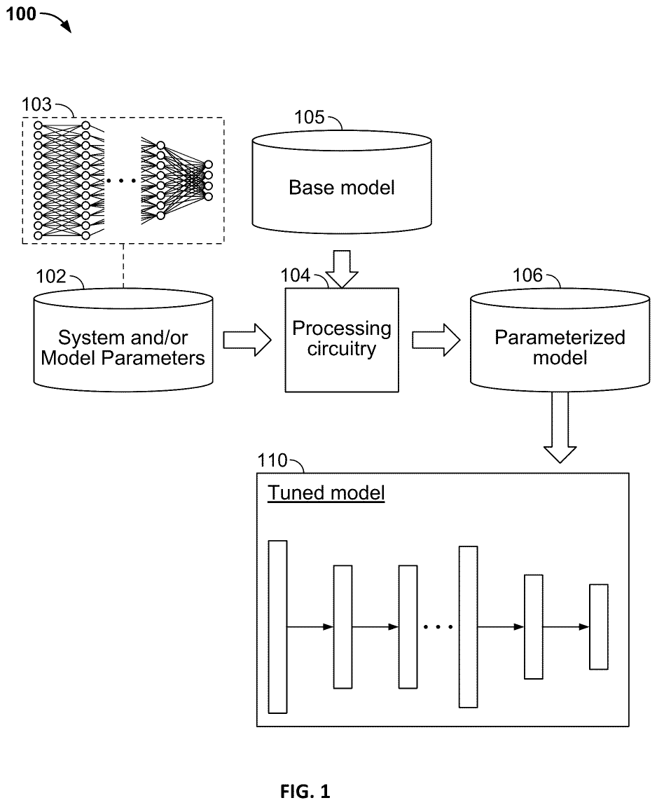

FIG. 1 depicts an example system 100 for generating a tuned model 110 using a parameterized base model 106, in accordance with some embodiments of this disclosure. The system 100 may include processing circuitry 104 to generate the parameterized model 106 and/or tuned model 110. It is contemplated that system 100 is provided as an illustrative, non-limiting example and that any suitable system may be included within the principles set forth in the present disclosure. For example, in some embodiments, the processing circuitry 104 may be configured to train the tuned model 110. In some embodiments, the processing circuitry 104 may be configured to transmit the tuned model 110 to one or more devices (not shown) for training the tuned model. In some embodiments, the parameterized model 106 is transmitted to one or more devices (not shown) that generate and/or train the tuned model 110.

At the system 100, the processing circuitry 104 receives configuration information such as system and/or model parameters 102 associated with a model 103. For example, the model 103 may have a model size such as a number of parameters (e.g., 200K, 500K, 1B, 1.5B, 2B, 7B, 10B, etc.) and/or may be of a model type. Some example model types include a transformer model, a generative adversarial network, a residual neural network, etc., variants thereof and/or combinations thereof. The processing circuitry 104 may be configured to determine a training configuration for the model 103 based on the received information (e.g., based on the model size and/or type). The processing circuitry 104 may access a base model 105 and/or associated information. For example, the processing circuitry 104 may access a transformer model with fewer parameters (e.g., 10K, 50K, 100K, etc.) than the model 103. The base model 105 may be optimized efficiently. In some embodiments, the information of the base model 105 may include one or more optimized hyperparameters (e.g., base width, base depth, aspect ratio, dataset size, batch size, number of training steps, etc.) that corresponds to an efficient training configuration. For example, the base model 105 may be trained with fewer compute operations using a configuration based on the optimized hyperparameters. In some embodiments, the base model 105 and/or associated information may be generated. For example, the base model 105 may be a scaled-down version of the model 103.

Optimized hyperparameters for the base model 105 may be determined using any suitable optimization techniques (e.g., grid search, random search, Bayesian optimization, evolutionary optimization, etc.). For example, optimized hyperparameters and/or an optimized aspect ratio of the base model 105 may be determined by minimizing the objective(s) (e.g., validation cross entropy loss, number of compute operations to train, etc.) using an optimization algorithm based on width and/or depth. For example, optimized hyperparameters and/or an optimized aspect ratio of the base model 105 may be determined using one or more heuristics.

The processing circuitry 104 may parameterize the base model 105 to generate a parameterization 106 of the base model 105. For example, the scaling of one or more hyperparameters may be determined based on the width and/or depth. In some embodiments, the associated information for the base model 105 may indicate the parameterization 106 of the base model 105. The processing circuitry 104 generates a tuned model 110 based on the parameterization 106 by tuning the model 103 using information from the parameterization 106. For example, the processing circuitry identifies a target aspect ratio using the parameterization 106, modifies the model width and/or model depth of the model 103 based on the target aspect ratio, and scales the optimized hyperparameters of the base model 105 based on the model width and/or the model depth.

The parameterization 106 of the base model 105 may enable transfer of optimized hyperparameters based on width and/or depth. For example, hyperparameters such as learning rate and/or weight initialization standard deviation may be determined based on the width and/or depth. For example, an optimal shape for the model 103 (e.g., based on optimized aspect ratio) may be determined such that the tuned model 110 can be trained more efficiently (e.g., in less time and/or fewer compute operations), freeing up resources that would otherwise be occupied. In some aspects, an optimized training configuration for the tuned model 110 may be determined without directly optimizing the model 103. The parameterization 106 may include one or more rules for scaling hyperparameters and/or model shape based on model size, model depth, model width, aspect ratio, etc. For example, the parametrization 106 may include one or more scaling rules associated with some model sizes (e.g., from about 50M to about 2B parameters or more), enabling interpolation and/or extrapolation of the factors for scaling hyperparameters and/or model shape based on model size, model depth, model width, aspect ratio, etc. In some aspects, the tuned model 110 is tuned such that the model shape allows for complete feature learning. For example, model depth may enable learning of hierarchical representations of data, wherein each layer may learn complex features based on output of the preceding layer(s). For example, model width may enable broader capture of independent features of the data.

As an illustrative example, processing circuitry 104 receives a decoder-based transformer language model with a large number of parameters (e.g., 1B or more parameters). The transformer model may have an initial model depth and/or an initial model width. For example, the transformer model may include a number of layers, each layer having a respective number of nodes. Determining a training configuration by optimizing the larger transformer model directly may be inefficient and compute-intensive, occupying significant resources that may be otherwise available for different tasks. In this example, the processing circuitry 104 may identify one or more smaller transformer models (e.g., having respective numbers of parameters) and associated information as the base model 105. The base model 105 may trained more efficiently (e.g., achieving acceptable accuracy in less overall time per iteration), allowing for iterative searching and/or optimization. For example, an optimizer may be used to determine an optimized aspect ratio for the base model 105. For example, a base width and/or base depth may be modified using the optimizer to determine an optimized aspect ratio and/or optimized hyperparameters. For example, the optimizer may modify base width and/or base depth concurrently to find an efficient training configuration for an acceptable accuracy. The efficient training configuration may be associated with an optimized set of hyperparameters, such as the learning rate and/or weight initialization standard deviation, for the base model 105. The base model may be parameterized to identify how the optimized training configuration scales with the optimized transformer shape. For example, the parameterization may ensure that the optimized training configuration remain compute-efficient for an aspect ratio range as the model size changes. For example, the one or more smaller transformer models may each be optimized to determine a trend for the optimized aspect ratio. Transfer of the optimizer hyperparameters may be determined using the parameterization. In some embodiments, the parameterization may indicate one or more hyperparameters remain about the same as model size increases. In some aspects, the parameterization indicates scaling based on any depth and/or width (e.g., scaling rules as depth and/or width grow to a large quantity).

Learning rate is a tunable hyperparameter that indicates step size per iteration and may affect rate of convergence and/or overshooting. In some embodiments, one or more model weights may be initialized for a model prior to training, e.g., by randomly sampling a distribution, wherein the sampling range may be tuned using the weight initialization standard deviation. Weight initialization and/or the sampling range may affect the training behavior such as speed of convergence, scale of activation, scale of gradient signals, and/or quality of the trained model. Some example rules for an illustrative parameterization are provided for learning rate and weight initialization. In this example, scaling factors may be respectively defined based on base width and base depth. For example, a first scaling factor may be the ratio of the target width and the base width, and a second scaling factor may be the ratio of the target depth and the base depth. The parameterization may indicate hyperparameter scaling based on one or more of the scaling factors. For example, the weight initialization standard deviation may scale based on the first scaling factor (e.g., multiplied by the target/base width ratio). For example, the learning rate may scale based on the second scaling factor (e.g., multiplied by the target/base depth ratio). For example, learning rate for one or more model layers (e.g., hidden layers) may scale based on the first and second scaling factors (e.g., multiplied by the target/base width ratio and the target/base depth ratio). It is noted that the aforementioned examples of hyperparameter scaling are intended to be illustrative and non-limiting. A parameterization may indicate any scaling rules for any suitable set of hyperparameters. It is noted that any hyperparameter, and variants thereof, (e.g., tokens per parameter (TPP), TPP behavior, biases, bias learning rate, weight decay, layer-wise parameters, etc.) may be included within the principles set forth in the present disclosure.

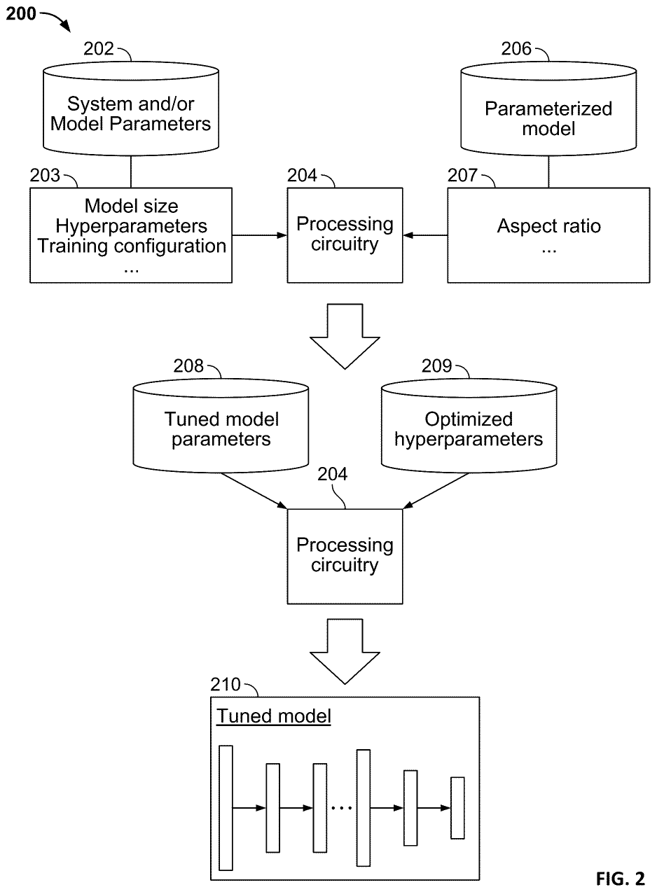

FIG. 2 depicts an example system 200 for determining tuned model parameters 208 and/or optimized hyperparameters 209 to generate a tuned model 210 using a parameterized base model 206, in accordance with some embodiments of this disclosure. One or more components of the system 200 may correspond to one or more components of the system 100 as described regarding FIG. 1. For example, processing circuitry 204 may correspond to processing circuitry 104. For example, the parameterized model 206 may correspond to the parameterization 106. At the system 200, processing circuitry 204 may receive data 202 including system and/or model parameters. For example, the data 202 may indicate an initial configuration 203 for a model (e.g., the model 103 of FIG. 1). For example, the processing circuitry 204 may determine model size, hyperparameters, a training configuration, a training dataset, etc., in the initial configuration 203. The processing circuitry 204 may receive a parameterized model 206 indicating information 207 for a base model such as an aspect ratio. The parameterized model 206 may correspond to the model having the system and/or model parameters from the data 202. In some embodiments, the information 207 indicates optimized hyperparameters and/or an optimized aspect ratio for a base model. The processing circuitry 204 determines tuned model parameters 208 and/or optimized hyperparameters 209 based on the information 207.

In some embodiments, the tuned model parameters 208 and/or the optimized hyperparameters 209 may be determined based on the optimized aspect ratio and/or the optimized hyperparameters of the base model. For example, data 202 may indicate a model width and a model depth. The processing circuitry 204 may identify a target aspect ratio based on the parameterized model 206. For example, the processing circuitry 204 may determine how the optimized aspect ratio scales with model size based on the parameterized model 206 and identify the target aspect ratio based on a target model size from the data 202. The processing circuitry 204 may modify one or more of the model width or the model depth to reach the target aspect ratio and keeping the target model size. For example, the model shape for the model to be trained may be adjusted such that the aspect ratio is 100:1, 10:1, etc., depending on the target aspect ratio. In some embodiments, the model width and the model depth are concurrently adjusted to achieve the target aspect ratio. As described regarding FIG. 1, one or more hyperparameters of the initial configuration 203 may be scaled based on the adjusted model shape (e.g., the model depth and/or the model width) to generate the optimized hyperparameters 209.

The processing circuitry 204 may generate the tuned model 210 using the tuned model parameters 208 and/or optimized hyperparameters 209. In some embodiments, the processing circuitry 204 may generate a compute-efficient training configuration based on the tuned model parameters 208 and/or the optimized hyperparameters 209. For example, the tuned model 210 may have a model shape that enables complete feature learning. For example, the tuned model 210 may have improved convergence and/or improved model quality (e.g., based in part on the residual blocks for a transformer model). The processing circuitry 204 may train the tuned model 210 using the compute-efficient training configuration. In some aspects, the parameterized model 206 enables transfer of the hyperparameters for a base model to larger models, ensuring that the tuned model parameters 208 and/or optimized hyperparameters 209 define a compute-efficient training configuration. In some embodiments, the parameterized model 206 may be used to define an aspect ratio range that enables a compute-efficient training configuration based on the tuned model parameters 208 and/or optimized hyperparameters 209.

As an illustrative example, a transformer model may include a plurality of residual blocks (e.g., multi-layer perceptron (MLP) layers and/or attention layers). Output of the residual blocks may be scaled based on depth and/or width after each iteration. For example, the output may be divided by a factor based on the depth. In some embodiments, the output may be divided by the depth to a power less than one (e.g., 0.5). In some embodiments, the output may be divided by the depth to a power of about one. For example, output of the MLP and/or attention blocks may be scaled using a depth-dependent scaling factor. Output of the residual blocks may be optimized, e.g., as part of the optimized hyperparameters 209. In some embodiments, output of the one or more residual layers may be scaled based on one or more scaling factors such as a depth-based factor and/or a width-based factor as described regarding FIG. 1. For example, output of an MLP layer may scale based on the depth-based factor. For example, output of an attention layer may scale based on the depth-based factor.

In some embodiments, the tuned model 210 may be tuned such that the model shape enables improved training based on system parameters (e.g., memory capacity, number of processor cores, processor frequency, etc.). For example, training a deeper model using a system with limited memory capacity may have increased latency. For example, shallow-wide models may be trained more efficiently for latency-sensitive applications. In some embodiments, a system includes memory and one or more devices, wherein respective model weights of the tuned model 210 are transmitted to each of the one or more devices. The respective model layers may be trained concurrently using the one or more devices. For example, the model layers of the tuned model 210 may be assigned to respective PEs. The respective model weights may be streamed from external memory to local memory of the assigned PEs. The PEs concurrently train the assigned model layers based on the respective model weights. In this example, the tuned model 210 may be shaped, e.g., as a narrow-deep model having an aspect ratio that is comparable to the target aspect ratio, enabling efficient streaming of the model layers to the assigned PEs and efficient training by the PEs. In some embodiments, the tuned model 210 may be shaped such that an aspect ratio is within a range around the target aspect ratio that enables compute-efficient training. The tuned model 210 may be efficiently trained and/or used for inference.

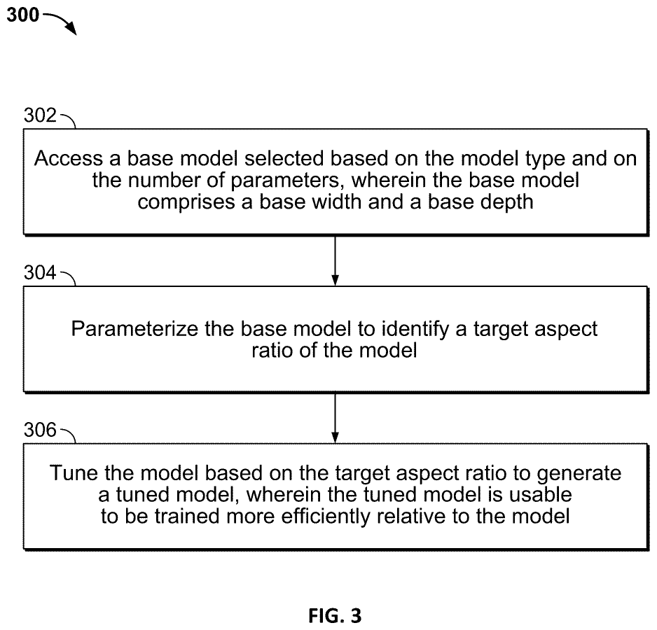

FIG. 3 is a flowchart of an example process 300 for tuning a model using a parameterized base model, in accordance with some embodiments of this disclosure. One or more blocks of the process 300 may be implemented using one or more components as described regarding any of FIGS. 1-2, 5-7. For example, one or more blocks of the process 300 may be performed by processing circuitry (e.g., processing circuitry 104, 204). In some embodiments, the process 300 may be implemented for configuring a model of a model type, wherein the model comprises a number of parameters. At block 302, a base model is accessed. The base model may be selected based on the model type and on the number of parameters. The base model may include a base width and/or a base depth. At block 304, the base model is parameterized (e.g., using processing circuitry). The parameterized base model may be used to identify a target aspect ratio of the model. At block 306, the model is tuned (e.g., using the processing circuitry) based on the target aspect ratio to generate a tuned model, wherein the tuned model is usable to be trained more efficiently relative to the model.

As an illustrative example, a system may include circuitry configured as one or more processors for training a model. The model may have a model type and include a number of parameters. For example, the model may be a residual network with a large model size. The circuitry may access a base residual network having a smaller model size. That is, executing the base residual network may involve significantly fewer operations (e.g., less compute time) than the larger model. The base residual network may have a base width and base depth. The circuitry may parameterize the base residual network. For example, the circuitry may determine an optimized aspect ratio for the base residual network and/or a parameterization of the optimized aspect ratio as the model size increases. For example, the circuitry may determine optimized hyperparameters of the base residual network (e.g., using an optimizer module). The circuitry may determine a target aspect ratio of the larger model. The circuitry may tune the larger model by adjusting the shape of the residual network based on the target aspect ratio. For example, the circuitry may adjust the residual network to have a narrow-deep model shape or have a shallow-wide model shape and maintain the number of parameters. For example, the circuitry may reduce the width by removing one or more nodes and/or increase the depth by adding one or more layers while the total number of nodes remains constant. The tuned residual network may be trained, e.g., by the circuitry using the one or more processors.

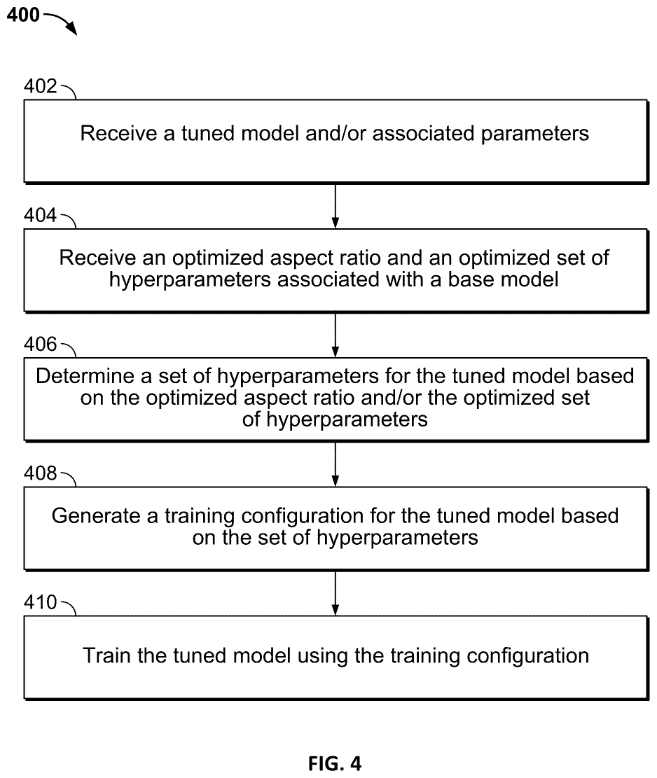

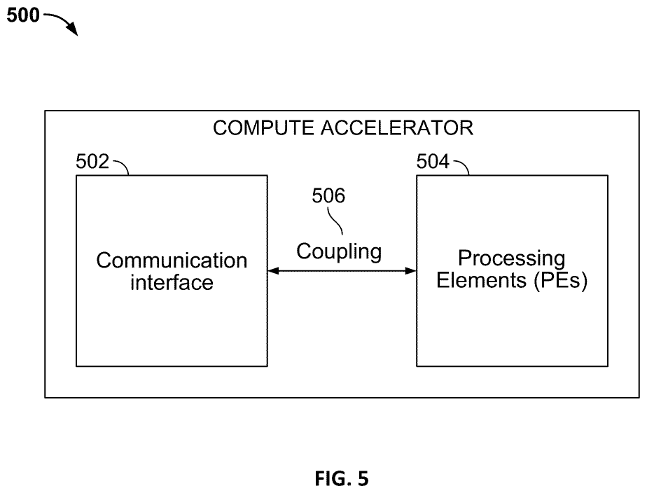

FIG. 4 is a flowchart of an example process 400 for generating a training configuration based on optimized hyperparameters of a base model and training a tuned model using the training configuration, in accordance with some embodiments of this disclosure. One or more blocks of the process 400 may be implemented using one or more components as described regarding any of FIGS. 1-2, 5-7. For example, one or more blocks of the process 400 may be performed by processing circuitry (e.g., processing circuitry 104, 204). For example, one or more blocks of the process 400 may be performed using one or more compute accelerators as described regarding FIGS. 5-7.

At block 402, a tuned model and/or associated parameters are received. For example, a compute accelerator may receive the model size, training dataset, initial weights, etc., for a tuned model. At block 404, an optimized aspect ratio and an optimized set of hyperparameters associated with a base model are received. At block 406, a set of hyperparameters is determined for the tuned model based on the optimized aspect ratio and/or the optimized set of hyperparameters. For example, one or more hyperparameters for the tuned model may be determined using a parameterization of the base model as described regarding FIGS. 1-2. For example, the optimized set of hyperparameters may be scaled based on width and/or depth to determine the set of hyperparameters for the tuned model. At block 408, a training configuration is generated for the tuned model based on the set of hyperparameters. At block 410, the tuned model is trained using the training configuration. For example, the tuned model may be trained using one or more compute accelerators as described regarding FIGS. 5-8.

FIG. 5 depicts a block diagram illustrating an example compute accelerator 500. Compute accelerator 500 includes a communication interface 502 and associated circuitry (e.g., input/output (I/O) circuitry) and one or more PEs 504, enabled to communicate with each other, as illustrated by Coupling 506. In some embodiments, communication interface 502 may include one or more field-programmable gate arrays (FPGAs). In some embodiments, one or more servers, devices, and/or other systems may be communicatively coupled to compute accelerator 500 using the interface 502. Compute accelerator 500 may be configured to perform processing (e.g., training and/or inference) with neural networks, such as by computing weights based on placement information and/or training information. Compute accelerator 500 may be configured to provide the weights as results via one or more communication paths (e.g., between PEs 504, between PEs 504 and interface 502, and/or to one or more other devices using the interface 502). In some embodiments, PEs 504 may include a relatively large number of PEs (e.g., about 10,000 or more), each PE configured to independently perform routing and/or computations. In some embodiments, compute accelerator 500 may include a large-chip device, wherein PEs 504 are implemented on a large substrate and configured to function analogous to a single chip. For example, respective pluralities of PEs may be implemented on respective dice of a single large substrate (e.g., a rack-width substrate, a substantially whole wafer, etc.). Interface 502 may be configured to couple one or more of PEs 504 to information provided via one or more communication paths using coupling 506. The coupling may include conversion to/from a first data structure (e.g., modified Ethernet frames, network packets, etc.) from/to a second data structure (e.g., fabric packets, network packets, etc.). In some embodiments, processing the information may include quantizing model weights or other values (e.g., converting from a floating-point number format to a fixed-point number format, encoding numerical values, decoding values in a block numeric format, etc.).

As used herein, the term “model parameter” or “parameter” refers to any model parameter including variables (e.g., model weights), number of layers, interlayer connections, number of nodes in a respective layer, etc., that may be adjusted during training and/or inference.

Any compute parameters described in the present disclosure may include any combination of scalars, vectors, matrices, tensors, and so forth, such as arrangements of an arbitrary number and an arbitrary complexity of elements. For example, the parameters are of various dimensions, such as one-dimensional, two-dimensional, three-dimensional, and otherwise multidimensional. For example, the parameters are of various datatypes, such as, integer and floating-point. For example, the parameters (or respective portions thereof, e.g., an exponent or a mantissa) are represented with various precisions (sometimes referred to as widths), such as, 8-bit, 16-bit, 32-bit, 64-bit, and so forth.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

An enumerated listing of items does not imply that any or all of the items are mutually exclusive, unless expressly specified otherwise.

The terms “a”, “an” and “the” mean “one or more”, unless expressly specified otherwise.

Devices, or components thereof, that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. For example, a variety of optional components may be described to illustrate the wide variety of possible embodiments. Further, although process steps, method steps, algorithms, or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it is noted that more than one device/article (whether or not they cooperate) may be used in place of a single device/article. Similarly, where more than one device or article is described herein (whether or not they cooperate), it is noted that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least particular operations that may have been illustrated in the figures show particular events occurring in a particular order. In some alternative embodiments, particular operations may be performed in a different order, modified, combined, or removed. Moreover, steps may be added to the above-described circuitry(ies) and conform to the described embodiments without departing from the principles set forth in the present disclosure. Some operations described herein may occur sequentially, and/or particular operations may be processed in parallel. Any operation may be performed by a single processor or by distributed processors.

As referred to herein, reference to a “substrate” are applicable to embodiments of a large substrate (e.g., a rack-width substrate, printed circuit board (PCB), organic substrate, a whole or substantially whole wafer, etc.) as well as to embodiments of a significant portion of a substrate (e.g., a significant portion of a wafer).

In some embodiments, a compute accelerator may include one or more specialized components, such as processing elements, device components, or other hardware elements. Some implementations include one or more processing circuit elements such as transistors, resistors, inductors, capacitors, wire interconnects, combinatorial logic (e.g., NAND, NOR) gates, latches, register files, memory arrays, tags for memory arrays, content-addressable memories, flash, ROM, DRAM, SRAM, Serializer/Deserializer (SerDes), I/O drivers, and the like, such as implemented via custom logic, synthesized logic, ASICs, and/or FPGAs. Some example processing elements include one or more application specific integrated circuits (ASICs), such as central processing units (CPUs), graphics processing units (GPUs), tensor processing units (TPUs), neural processing units (NPUs), etc., including combinations and/or variants thereof. One or more compute accelerators may include processing elements coupled via a unifying compute fabric (“fabric” henceforth) and enabled to communicate with each other via the fabric. The processing elements and the fabric may be collectively referred to as a fabric of processing elements on a single compute accelerator or a plurality of compute accelerators coupled to each other.

In some embodiments, a processing element includes a router to communicate data packets (e.g., network packets, fabric packets, etc.) via the fabric and a compute element (CE) to process the data packets. In some embodiments, a router may be coupled to a plurality of elements: a fabric, an off ramp to the CE, and an on ramp from the CE. In some embodiments, a coupling between the router and the fabric enables communication between the router and, e.g., four logically and/or physically adjacent processing elements. The router variously receives data packets from the fabric and the on ramp. The router variously transmits data packets to the fabric and the off ramp.

In some embodiments, a CE includes hardware elements that collectively execute the instructions based on receiving an associated data packet by performing operations specified by the instructions (e.g., arithmetic operations, control flow operations, and load/store operations). In some embodiments, the instructions are provided to the compute element separately from the associated data packet. Examples of some hardware elements include picker queues, a picker, a task definition table, an instruction sequencer, an instruction decoder, a data sequencer, a register file, a memory, a pseudo-random number generator, and an arithmetic logic unit (ALU). Some implementations of the hardware elements are in accordance with hardware logic circuitry elements as described elsewhere herein. A CE may be referred to as a compute engine. A compute scheduler may be referred to as a picker, and a compute scheduler queue may be referred to as a picker queue. A CE may be configured to process data packets by initiating tasks and executing instructions associated with the data packets, and accessing data associated with the data packets and/or the instructions. The instructions are in accordance with an instruction set architecture comprising arithmetic instructions, control flow instructions, datatype conversion instructions, configuration instructions, fabric management instructions, and load/store instructions. The instructions operate on operands comprising various datatypes, e.g., integer datatypes and floating-point datatypes of various widths. The operands variously comprise scalar operands and vector operands. In some embodiments, a vector variously represents, e.g., weights of a neural network, inputs or stimuli of a neural network, activations of a neural network, and/or partial sums of a neural network. In some scenarios, a vector is a sparse vector (e.g., a vector of neuron activations) and comprises sparse data elements (e.g., only non-zero elements). In some other scenarios, a vector is a dense vector (e.g., pixel values) and comprises dense data elements (e.g., all elements of the vector, including zero elements).

In some embodiments, a fabric includes a collection of logical and/or physical couplings between processing elements and/or within a single processing element. The fabric may be configured to implement logical and/or physical communication topologies such as a mesh, a 2D mesh, a 3D mesh, a hypercube, a torus, a ring, a tree, or any combination thereof. In some embodiments, a physical coupling between processing elements may include a set of physical interconnects (comprising optional and/or selective buffering) between physically-coupled processing elements. A first example of physically-coupled processing elements is immediately physically adjacent processing elements, such as a first processing element located directly beside (such as ‘north’, ‘south’, ‘east’, or ‘west’) of a second processing element. A second example of physically-coupled processing elements is relatively physically nearby processing elements, such as a first processing element located within a relatively small number of intervening processing elements, e.g., one or two ‘rows’ and/or ‘columns’ away from a second processing element. A third example of physically-coupled processing elements is relatively physically far away processing elements, such as a first processing element located physical relatively far away from a second processing element, such as a distance limited by signal propagation (with or without optional and/or selective buffering) within a clock cycle and/or clock sub-cycle associated with the processing elements. An example of physical coupling within a single processing element (having, e.g., a compute element and a router) is an on ramp coupling output information from the compute element to the router, and an off ramp coupling input information from the router to the compute element. In some embodiments, the router routes information from the on ramp to the off ramp. The router may route from the on ramp and through a number of zero or more hops to one or more consecutively adjacent routers and/or zero or more off-ramps (e.g., a plurality of off-ramps).

In some embodiments, memory or storage includes one or more elements enabled to retain state information, e.g., any one or more of: a flip-flop, a latch or an array of latches, a register or an array of registers, a register file, a memory, a memory array, a magnetic storage device, an optical storage device, SRAM, DRAM, flash, and ROM. In some embodiments, storage is volatile (e.g., SRAM or DRAM) and/or non-volatile (e.g., flash or ROM).

In some embodiments, a compute accelerator may include wafer-scale integration by implementing a system using all or a significant portion of a large substrate as an element of the system, e.g., by leaving a large substrate whole or substantially whole with relatively little or no singulation. In some embodiments, wafer-scale integration enables connecting multiple elements in a system via substrate interconnects formed using semiconductor fabrication processes instead of via inter-chip interconnect, and may improve any one or more of improved performance, cost, reliability, and energy efficiency. As an illustrative example, a system implemented using wafer-scale integration technology enables implementation of more than one billion PEs on a single substrate, each of the PEs having bandwidth to nearest physical neighbors that is greater than a comparable system using other-than wafer-scale integration technology. The greater bandwidth enables the system implemented using wafer-scale integration technology to relatively efficiently train and/or perform inferences for larger neural networks than the system implemented using other-than wafer-scale integration technology.

In some embodiments, a logical coupling between processing elements includes one or more communication channels (e.g., one or more virtual channels) as implemented by routers within processing elements. A route between a first processing element and a second processing element is implemented, e.g., by routers within processing elements along the route forwarding in accordance with the communication channel and routing configuration information. An example of a logical coupling within a single particular processing element (having, e.g., a router) is a communication channel as implemented by the router, enabling the particular processing element to send information via the communication channel to the particular processing element. The router forwards with respect to the particular processing element in accordance with the communication channel and routing configuration information.

In some embodiments, a data packet (e.g., fabric packets, network packets, etc.) includes a bundle of information communicated between processing elements via the fabric. A data packet may be referred to as a wavelet in some embodiments. In some embodiments, a data packet may include one or more fields indicative of a payload and/or a communication channel (e.g., a communication channel identifier). A payload may include data and may be associated with instructions. For example, a first response to a data packet received by a compute element of a processing element may include the compute element initiating a task, such as corresponding to processing of instructions associated with the data packet. For example, a second response to a data packet received by a compute element of a processing element may include the compute element processing data of the data packet. Some example types of data packets include dense packets and sparse packets, as well as data-type and control-type.

Data packets may be used, for example, for communicating between processing elements. For example, a first processing element may transmit data packets to a second processing element. For example, an external device (e.g., from interface 502) may transmit data packets to a processing element. For example, a processing element transmits data packets to an external device (e.g., using interface 502).

In some embodiments, a communication channel includes one or more communication pathways specified by a communication channel identifier (e.g., a color field) and may be enabled, e.g., by a fabric and one or more routers. A communication channel may be referred to as a virtual channel in some embodiments. A data packet including a particular communication channel identifier is sometimes referred to as being associated with a particular communication channel (e.g., associated with a particular color). A first example of a communication channel identifier may be a fabric color specifying a communication channel between two different processing elements. In some embodiments, a communication channel identifier is a 5-bit integer. A second example of a communication channel identifier is a local color specifying a communication channel from a processing element to the processing element. In some embodiments, a communication channel identifier is a 6-bit integer and specifies one of a fabric color and a local color.

An example task may include a collection of instructions executed in response to a data packet. An example instruction may include an operation and optionally one or more operands specifying locations of data elements to be processed in accordance with the operation. A first example of an operand specifies data elements in memory. A second example of an operand specifies data elements communicated (e.g., received or transmitted) via the fabric. An example of a data sequencer determines the locations of data elements. An example of an instruction sequencer determines an address in memory of instructions associated with a data packet.

An example picker queue is enabled to hold data packets received via an off ramp of the fabric for processing in the compute element. An example of a picker selects a data packet from the picker queue for processing, and/or selects an active unblocked virtual channel identifier for processing to initiate a corresponding task.

An example of an integrated circuit (IC) is a collection of circuitry implemented on one or more portions of semiconductor material, such as a single die or a plurality of dies. An example of 3D-stacking of dies is providing mechanical connectivity and/or electrical connectivity between the dies, e.g., in a dimension orthogonal to a major surface of the dies, to form a unit. The mechanical connectivity and/or the electrical connectivity are variously implemented, e.g., via one or more of solder balls, microbumps, hybrid bonds, and through-substrate vias. An example of 2.5D stacking of dies is providing mechanical connectivity and/or electrical connectivity between the dies via a common element (e.g., an interposer) to form a unit, wherein the mechanical connectivity and/or electrical connectivity between each die and the substrate is in a dimension orthogonal to a major surface of the die. The mechanical connectivity and/or the electrical connectivity are variously implemented, e.g., via one or more of solder balls, microbumps, and through-substrate vias. An example of an application-specific integrated circuit (ASIC) is an IC configured for a particular use or application.

An example of a package is an element enabled to mechanically retain and/or contain one or more electronic circuits and/or to electrically interconnect one or more electronic circuits. Example electronic circuits are any one or more of one or more portions of semiconductor material, one or more dice, one or more interposers, and one or more substrates. Particular examples of packages include a ball-grid array (BGA) package and variants thereof. Some ICs include a package. An example of a substrate is an element to mechanically retain and/or electrically interconnect one or more dice and/or one or more packages. An example of a substrate includes a PCB, to, e.g., retain and interconnect packages. An example of a substrate includes an interposer to, e.g., couple one or more 3D-stacked or 2.5-stacked dice. An example of a substrate includes a package, e.g., retaining a plurality of dice.

An example of inter-package communication is communication between packages, e.g., between a first package and a second package. A particular example of inter-package communication is communication between a first BGA mounted on a PCB and a second BGA mounted on the PCB. An example of intra-package communication is communication within elements of a package. A particular example of intra-package communication is communication between a first die in a package and a second die in the package. An example of intra-substrate communication is communication between elements of a substrate, such as between a first package mounted on a PCB and a second package mounted on the PCB. An example of inter-die communication is communication between dice, such as between a first 3D-stacked die of a package and a second 3D-stacked die of the package. Some inter-die communication is in accordance with intra-package communication. Some inter-die communication is in accordance with intra-substrate communication. An example of intra-die communication is communication between elements of a same die, such as between electrically interconnected routers of a same die.

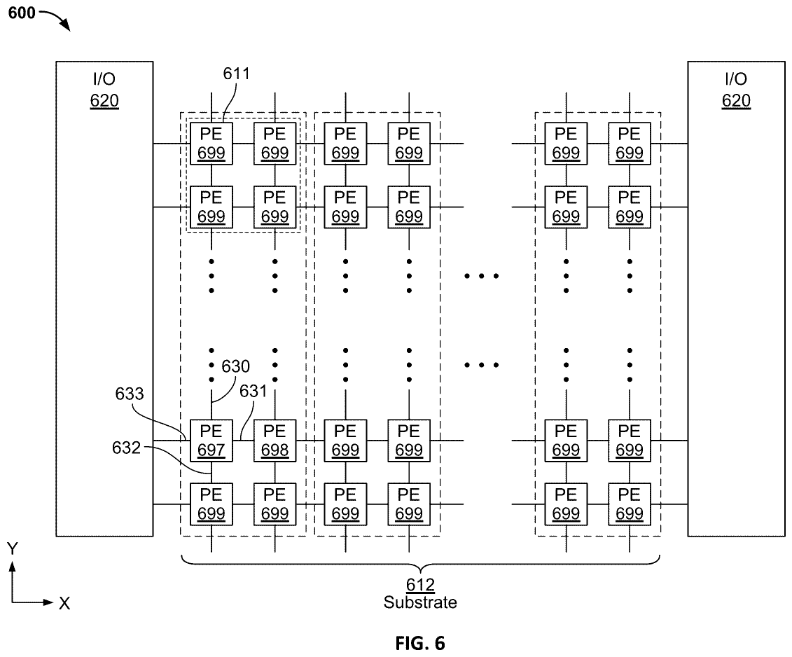

FIG. 6 depicts an example configuration of a compute accelerator 600 including a plurality of PEs disposed at a single substrate 612, in accordance with some embodiments of this disclosure. Each of PE 699 elements has couplings to other of PE 699 elements. Two of the PE elements (e.g., PE 697 and PE 698) are illustrated with unique identifiers and may be otherwise respectively identical to instances of PE 699. PE 697 is illustrated with identifiers for each of four couplings (North coupling 630, East coupling 631 with PE 698, and South coupling 632) to others of the PEs and one of the I/O 620 (West coupling 633) and may be otherwise identical to others of the PE elements illustrated. In some embodiments, the couplings are logical and/or physical. In some embodiments, the couplings are usable to communicate control packets, instructions, data packets, backpressure information, configuration information, routing information, etc. In some embodiments, all or any portions of the physical couplings are to physically adjacent PEs. In some embodiments, the PEs are physically implemented in a 2D grid. In some embodiments, the PEs are physically implemented in a 2D grid of aligned rectangles, and physically adjacent PEs correspond to PEs sharing a horizontal boundary (North/South PEs with respect to each other) and PEs sharing a vertical boundary (East/West PEs with respect to each other).

In some embodiments, the PEs (e.g., PEs 697, 698, 699) may include or be ASICs. For example, an array of identical instances of an ASIC may be formed on a substrate, and each of the ASICs includes a plurality of identical instances of a same PE (e.g., PE 699), forming a substrate (e.g., substrate 612) usable in large-chip fabrication techniques (e.g., wafer-scale integration). In some embodiments, one or more peripheral portions of the PEs are coupled to I/O 620. For example, I/O 620 may include a plurality of FPGAs configured to couple the PEs to external devices or other PEs. The PEs may be organized in any suitable manner such as sections of columns (e.g., replicated in a one-dimensional fashion to form a column). In some embodiments, the PEs may be organized in reticles such as reticle 611 including a square-organized section or a rectangular-organized section of PEs (e.g., replicated in a two-dimensional fashion to form a rectangular shape). Other organizations of the PEs on a substrate may be included in the principles set forth in the present disclosure.

In some embodiments, a set of parallelizable tasks may be mapped to one or more PEs 699 such that associated computations may be concurrently performed by the mapped PEs. In some embodiments, neurons associated with layers in a model (e.g., one or more neural networks) may be generally placed on PE 699 elements (e.g., in a left to right fashion or any other direction), with earlier layers (e.g., the input layer) at a first end and subsequent layers (e.g., the output layer) at a second end. As an illustrative example, data flow during training and/or inference may include three example stages, forward stage, delta stage, and/or chain stage. During the forward stage, stimuli may be applied to the input layer and activations from the input layer flow to subsequent layers, eventually reaching the output layer and producing a forward result. During the delta stage, deltas (e.g., differences between the forward result and the output data) are propagated in the backward direction. During the chain stage, gradients are calculated down respective columns based on the deltas (e.g., with respect to the weights in the neurons) as they are generated during the delta stage. In some embodiments, processing for one or more stages (e.g., forward, delta, chain) may be substantially overlapped with processing for another stage (e.g., chain).

In some embodiments, one or more components of compute accelerator 600 may correspond to one or more components of compute accelerator 500. In some embodiments, individual PE 699 elements correspond to individual PEs of PEs 504 of FIG. 5. In some embodiments, PEs 699 including respective ASIC elements correspond to any or all portions of PEs of PEs 504 implemented as individual integrated circuits. In some embodiments, PEs 699 including respective ASIC elements correspond to (optionally identical) any or all portions of PEs of PEs 504 implemented via respective dice of a substrate. In some embodiments, I/O 620 elements may correspond to interface 502 of FIG. 5.

In some embodiments, substrate 612 includes any one or more of a large substrate, an entire wafer, a portion of a wafer, a single ASIC, a plurality of ASICs, a plurality of dice, a plurality of 3D-stacked dice, and/or a PCB comprising one or more of the foregoing. For a first example, substrate 612 may include a portion of a wafer corresponding to a largest rectangle, according to physical granularity of the PEs (e.g., fitting inside an entire substantially circular wafer). For a second example, substrate 612 includes a grid arrangement of ASICs coupled via a PCB, each ASIC comprising a plurality of PEs.

In some embodiments, compute accelerator 600 may include a scaled compute fabric. In some embodiments, one or more PEs 699 may have a different amount of memory than the one or more other PEs 699. In some embodiments, one or more PEs 699 may utilize a different coupling technology than the one or more other PEs 699. In some embodiments, one or more PEs 699 may be implemented to use more power than the one or more other PEs 699, enabling, e.g., operation at a higher frequency. In some embodiments, one or more PEs 699 may be implemented to use less power than the one or more other PEs 699, restricting, e.g., operation to a lower frequency. In some embodiments, one or more PEs 699 or groups thereof may be configured for higher performance and/or configured to include increased local storage of data (e.g., weights), such as in a context of larger neural networks or other models. In some embodiments, groups of PEs 699 may be organized as compute clusters including respective high-bandwidth memory (HBM) or other memory coupled to the group.

In some embodiments, the PEs 699 may be coupled using a fabric. The fabric operates as a communication interconnect between all the PEs in the compute accelerator 600. For example, the fabric may be configured to transfer data packets, e.g., via 30-bit physical couplings to enable transfer of an entire data packet per cycle (e.g., core clock cycle). In some embodiments, the fabric is a local interconnect distributed throughput the PEs such that each PE is enabled to communicate directly with its (physical) neighbors. Communication to other-than (physical) neighbors may be performed via hops through intermediate nodes, e.g., others of the PEs, wherein the intermediate nodes are configured to route the information to the appropriate port without processing the information. In some embodiments, a distributed local fabric topology efficiently maps to a neural network workload, e.g., each layer sends data to a neighboring layer) and/or is implementable with relatively lower cost in hardware. As an illustrative example, compute accelerator 600 may include a fabric having a 2-D mesh of interconnects between neighboring PEs including “skip” connections (e.g., in the horizontal dimension) and/or “loop” connections (e.g., in the vertical dimension). Neighboring PEs may communicate with each other within about one or more time steps using the fabric. In this example, a skip connection enables PEs in a same row of the 2-D mesh and physically separated by one or more other PEs to communicate with each other as if the PEs were physically adjacent (e.g., within about one or more time steps). For example, a hop along a skip connection may be performed in about a single core clock cycle. In this example, a loop connection enables a PE at the bottom of a column of PEs to communicate with a PE at the top of the column as if the PEs were physically adjacent (e.g., within about one or more time steps). For example, a hop along a loop connection is performed in a single core clock cycle. It is noted that skip connections and/or loop connections may be configured to pass any number of intermediate nodes (e.g., any number of intervening PEs 699).

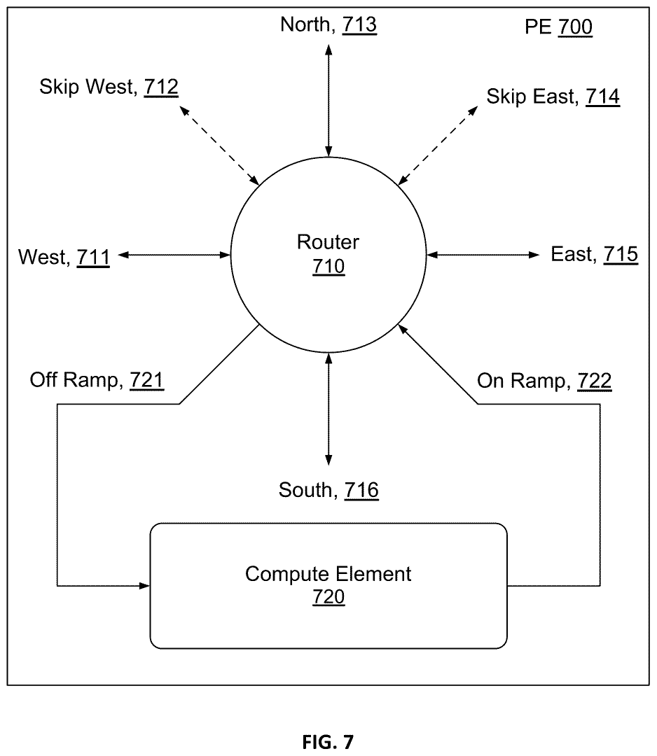

FIG. 7 depicts a block diagram illustrating an example processing element 700 and some components thereof, in accordance with some embodiments of this disclosure. PE 700 includes router 710 and CE 720. Router 710 may be configured to selectively and/or conditionally communicate (e.g. transmits and receives) packets between other PEs (e.g., logically adjacent and/or physically adjacent PEs) and PE 700 via couplings 711-716. Couplings 711-716 are illustrated as bidirectional arrows to emphasize the bidirectional communication of data packets on the couplings. For example, backpressure information may be transmitted on the couplings in the reverse direction of packet information the backpressure corresponds to. Router 710 may be configured to selectively and/or conditionally communicate packets to PE 700 (e.g., CE 720) via Off Ramp 721 and communicates data packets from PE 700 (e.g., CE 720) via On Ramp 722. Off Ramp 721 is illustrated as a unidirectional arrow to emphasize the unidirectional communication of data packets on the coupling (e.g., from router 710 to CE 720). For example, backpressure information may be transmitted on the coupling in the reverse direction of packet information (e.g., from CE 720 to router 710). On Ramp 722 is illustrated as a unidirectional arrow to emphasize the unidirectional communication of data packets on the coupling (e.g., from CE 720 to router 710). For example, backpressure information may be transmitted on the coupling in the reverse direction of packet information (e.g., from router 710 to CE 720).

Compute Element 720 may be configured to perform computations on data embodied in the received packets according to instruction address information, e.g., derivable from the packets. The instruction address information is used to identify starting addresses of tasks embodied as instructions stored in storage (e.g., any one or more of memory, cache, and register file(s)) of the CE. Results of the computations are selectively and/or conditionally stored in the storage and/or provided as data embodied in data packets communicated to the router for, e.g., transmission to the other PEs and or PE 700.

Each router may have five ports (e.g., couplings 711-716), connecting one each to its immediate cardinal neighbors using a fabric and to the local PE. Routers may forward data packets (e.g., messages of a compact size such as 32-bit messages) with low latency (e.g., on the order of nanoseconds). Each router may have any number of communication channels, such as 24 or more virtual channels. A virtual channel may multicast traffic arriving from any one of the five ports to any subset of the five ports. Routers may change the communication channel designation of a packet as it is forwarded.

Router 710 may selectively and/or conditionally communicates (e.g. transmits and receives) backpressure information between the other PEs and PE 700 via couplings 711-716. Router 710 selectively and/or conditionally transmits backpressure information to PE 700 via On Ramp 722. Router 710 receives backpressure information from PE 700 via Off Ramp 721. The backpressure information provided to the other PEs, as well as the backpressure information provided to PE 700, is used by the other PEs and PE 700 to stall transmitting data (e.g., packets) that would otherwise be lost due to insufficient queue space to store the data in Router 710. The backpressure information received from the other PEs and PE 700 is used respectively by Router 710 to prevent transmitting data (e.g., packets) that would otherwise be lost due respectively to insufficient queue space in the routers of the other PEs and insufficient space in input queues of Compute Element 720.

In various embodiments, any one or more of 711-716 are omitted.

In some embodiments, PE 700 is an embodiment of PEs 699, and/or elements of PE 700 correspond to an implementation of PEs 699. In some embodiments, North 713, East 715, South 716, and West 711 correspond respectively to North coupling 630, East coupling 631, South coupling 632, and West coupling 633.

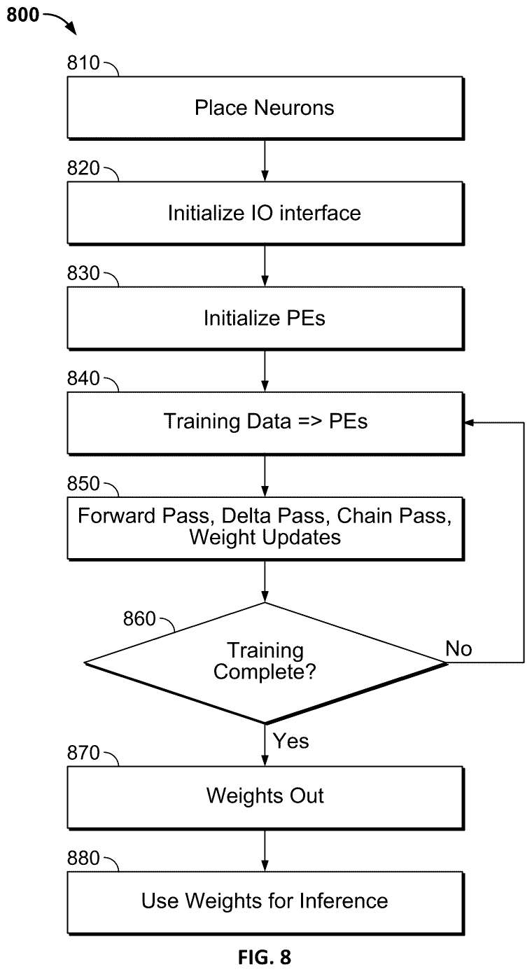

FIG. 8 is a flowchart of an example process 800 for training a model and/or performing inference using the trained model. In some embodiments, training the model and/or performing inference using the trained model may include using one or more compute accelerators such as any of the systems 500 and/or 600. It is noted that the following paragraphs refer to a neural network as an illustrative, non-limiting example and that any deep learning model, and variants thereof, may be included within the principles set forth in the present disclosure. A training configuration of the process 800 may be determined as described in preceding paragraphs regarding FIGS. 1-4.

At block 810, neurons of the neural network are placed, e.g., allocated and/or associated with specific PE resources. At block 820, interface resources (e.g., I/O resources, FPGA resources, etc.) are initialized in preparation for training of the neural network. At block 830, the PE resources are initialized in preparation for training of the neural network.

After the interface resources and PE resources are initialized in preparation for the training, training data is applied to the PEs at block 840. At block 850, the PE resources process the training data. At block 860, a check may be made to determine if training is complete, e.g., because application of the training data is complete and/or one or more completion criteria are met (such as an inference error below a predetermine bound). If not, then flow passes back to block 840 for application of further training data. In some embodiments, the training does not complete, and control passes to another action (not shown) to enable changing, for example, hyperparameters of the neural network (e.g., any one or more of: adding layers of neurons, removing layers of neurons, changing connectivity between neurons, changing the batch size, and changing the learning rule). For example, the neural network may be further tuned as described regarding FIGS. 1-4. The neural network is then trained in accordance with blocks 810, 820, 830, 840, 850, and 860.

If training is complete, then flow continues to provide weights that are results of the training for use in inferences at block 870. In some embodiments, the weights may be quantized, e.g., transformed to an integer data format, a block numeric format, etc. In some embodiments, the integer data format is a reduced precision number format (e.g., 8-bit or 16-bit). In some embodiments, the block numeric format retains the original precision of the weights. The weights are then provided to one or more inference engines and used to make inferences at block 880. In some embodiments, the trained model and/or associated weights may be transmitted to one or more compute accelerators for inference.

The methods, systems, apparatuses, etc., discussed herein are intended to be illustrative and non-limiting. One skilled in the art would appreciate that the parts of the methods, systems, apparatuses, etc., discussed herein may be omitted, modified, combined and/or rearranged, and any additional parts may be included, and/or any additional steps may be performed without departing from the scope of the present disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. It should also be noted that the systems and/or methods described above may be applied to, or used in accordance with, other systems and/or methods. Throughout the specification the phrases “in response to,” “based on,” and “based at least in part on” shall be understood to have a broad meaning unless context requires otherwise. For example, “in response to” can refer to a step that is in direct or indirect response to a prior step, and “based on” can refer to a step that is based at least in part on a prior step.

What is claimed is:

1. A computer-implemented method for configuring a model of a model type, wherein the model comprises a number of parameters, the method comprising:
accessing a base model selected based on the model type and on the number of parameters, wherein the base model comprises a base width and a base depth;
parameterizing, using processing circuitry, the base model to identify a target aspect ratio of the model; and
tuning, using the processing circuitry, the model based on the target aspect ratio to generate a tuned model, wherein the tuned model is usable to be trained more efficiently relative to the model.

2. The method of claim 1, further comprising generating the base model.

3. The method of claim 1, wherein the model comprises a model depth and a model width, and wherein parameterizing the base model comprises:
determining, based on at least one of the base width or the base depth, an optimized aspect ratio of the base model, wherein the optimized aspect ratio is associated with an optimized set of hyperparameters of the base model; and
identifying the target aspect ratio based on the optimized aspect ratio.

4. The method of claim 3, wherein tuning the model comprises modifying at least one of the model depth or the model width based on the target aspect ratio.

5. The method of claim 3, further comprising tuning a training configuration of the model to determine a set of hyperparameters of the tuned model based on the target aspect ratio.

6. The method of claim 5, wherein determining the set of hyperparameters comprises re-scaling the optimized set of hyperparameters using at least one of the model depth or the model width.

7. The method of claim 5, wherein the set of hyperparameters comprises one or more of a learning rate, a weight decay, a batch size, a dataset size, a number of training steps, or a training step size.

8. The method of claim 3, wherein the model comprises at least one residual layer, and wherein an output of the at least one residual layer is scaled using the model depth.

9. The method of claim 8, wherein the output is divided by the model depth to the power of one.

10. The method of claim 1, further comprising training the tuned model, wherein training the tuned model comprises using fewer compute operations relative to training the model.

11. The method of claim 1, wherein a plurality of model weights of the tuned model is stored in memory coupled to one or more devices, the method further comprising:
transmitting, from the memory, respective model weights of the tuned model to each of the one or more devices; and
concurrently training respective model layers of the tuned model based on the respective model weights using the one or more devices.

12. A system for configuring a model of a model type, the system comprising processing circuitry configured to:
access a base model selected based on the model type and on the number of parameters, wherein the base model comprises a base width and a base depth;
parameterize the base model to identify a target aspect ratio of the model; and
tune the model based on the target aspect ratio to generate a tuned model, wherein the tuned model is usable to be trained more efficiently relative to the model.

13. The system of claim 12, wherein the processing circuitry is further configured to generate the base model.

14. The system of claim 12, wherein the model comprises a model depth and a model width, and wherein the processing circuitry, when parameterizing the base mode, is configured to:
determine, based on at least one of the base width or the base depth, an optimized aspect ratio of the base model, wherein the optimized aspect ratio is associated with an optimized set of hyperparameters of the base model; and
identify the target aspect ratio based on the optimized aspect ratio.

15. The system of claim 14, wherein the processing circuitry, when tuning the model, is configured to modify at least one of the model depth or the model width based on the target aspect ratio.

16. The system of claim 14, wherein the processing circuitry is further configured to:
tune a training configuration of the model to determine a set of hyperparameters of the tuned model based on the target aspect ratio.

17. The system of claim 16, wherein the processing circuitry, when determining the set of hyperparameters, is configured to re-scale the optimized set of hyperparameters using at least one of the model depth or the model width.

18. The system of claim 16, wherein the set of hyperparameters comprises one or more of a learning rate, a weight decay, a batch size, a dataset size, a number of training steps, or a training step size.

19. The system of claim 14, wherein the model comprises at least one residual layer, and wherein an output of the at least one residual layer is scaled using the model depth.

20. The system of claim 19, wherein the output is divided by the model depth to the power of one.
